(19) United States
(12) Patent Application Publication
(10) Pub. No.: US 2015/0358860 A1
(43) Pub. Date: Dec. 10, 2015

(54) METHOD, DEVICE, AND SYSTEM FOR HANDOVER OF USER EQUIPMENT GROUP

(71) Applicant: HUAWEI TECHNOLOGIES CO., LTD., Shenzhen (CN)

(72) Inventors: Zhenwei LU, Beijing (CN); Song ZHU, Beijing (CN); Fei YANG, Shenzhen (CN); Yue LI, Shenzhen (CN); Xiaolong GUO, Beijing (CN)

(73) Assignee: HUAWEI TECHNOLOGIES CO., LTD., Shenzhen (CN)

(21) Appl. No.: 14/828,985

(22) Filed: Aug. 18, 2015

Related U.S. Application Data
(63) Continuation of application No. PCT/CN2013/071641, filed on Feb. 18, 2013.

(51) Int. Cl. H04W 36/00; H04W 74/08

(52) U.S. Cl. CPC H04W 36/0005; H04W 74/0833; H04W 36/08

(57) ABSTRACT

A method includes: determining, according to a measurement report of agent UE and a measurement report of UE in a UE group that are sent by the agent UE, whether the agent UE and the UE in the UE group need to be handed over; when the agent UE and at least one piece of UE in the UE group need to be handed over, sending a handover request message to a T-eNB; receiving a handover configuration message sent by the T-eNB and sending the handover configuration message to the agent UE; and receiving a context release message sent by the T-eNB, and releasing context resources of the agent UE and the to-be-handed-over UE.

### CROSS-REFERENCE TO RELATED APPLICATIONS

This application is a continuation of International Application No. PCT/CN2013/071641, filed on Feb. 18, 2013, which is hereby incorporated by reference in its entirety.

### TECHNICAL FIELD

Embodiments of the present invention relate to the field of wireless network communications, and in particular, to a method, device, and system for handover of a user equipment group.

### BACKGROUND

MUCC (Multiple UEs Cooperative Communication,) refers to that: when an eNB (evolved NodeB) communicates with UE (user equipment), the UE may directly communicate with the eNB or may communicate with agent UE (also referred to as S-UE, that is, supporting user equipment) near the UE, and after the agent UE forwards data to the UE, communication is performed between the two UEs. In this way, UE with an optimal channel condition may be selected as the agent UE to transmit uplink and downlink data, so as to achieve an effect of multiuser diversity. Single link MUCC refers to that: agent UE acts as an agent for one or more UEs to communicate with an eNB, and the agent UE and the UEs form a UE group, where the agent UE and the eNB are connected in a synchronized state, the UEs and the eNB are connected in an out-of-synchronization state, and uplink data can be sent only by using the agent UE. When locations of the agent UE and the UEs for which the agent UE acts as an agent change, it may be necessary to hand over a serving eNB for the UE group.

Currently, when the agent UE and the UEs for which the agent UE acts as an agent need to perform handover, each piece of UE (including the agent UE and the UEs) that is in the UE group and that is allowed to perform handover needs to be handed over from an S-eNB (Serving eNB, serving eNB) to a T-eNB (target eNB), and each piece of UE that is allowed to perform handover needs to initiate a random access process, to separately perform handover.

During implementation of the present invention, the inventor finds that the prior art has at least the following problems:

In a process of handover of a UE group in the prior art, agent UE and each piece of UE to be handed over all need to initiate a random access process, to separately perform handover, which leads to a need of consuming a large quantity of Preambles and signaling; and for UEs in a single link MUCC state, as long as the UEs do not break off a cooperative relationship with the agent UE, the UEs still need to return to the out-of-synchronization state after being switched to the synchronized state, therefore it is unnecessary to perform an additional synchronization process for handover.

### SUMMARY

In order to resolve the problems in the prior art, embodiments of the present invention provide a method, device, and system for handover of a user equipment group. Technical solutions are as follows:

According to a first aspect, an embodiment of the present invention provides a method for handover of a user equipment group, where the method includes:

determining, according to a measurement report of the agent user equipment UE and a measurement report of UE in a UE group that are sent by the agent UE, whether the agent UE and each piece of UE in the UE group need to be handed over, where the UE group includes the agent UE and each piece of UE;

when the agent UE and at least one piece of UE in the UE group need to be handed over, sending a handover request message to a target base station T-eNB, where the handover request message includes at least context information of the agent UE and the at least one piece of to-be-handed-over UE that needs to be handed over and a cooperative relationship between the agent UE and the to-be-handed-over UE;

receiving a handover configuration message sent by the T-eNB and sending the handover configuration message to the agent UE, where the handover configuration message includes at least a physical random access channel PRACH resource and a cell radio network temporary identifier C-RNTI that are allocated by the T-eNB to the agent UE and a C-RNTI that is allocated by the T-eNB to each piece of to-be-handed-over UE that needs to be handed over; and receiving a context release message sent by the T-eNB, and releasing context resources of the agent UE and the to-be-handed-over UE.

In a first possible implementation manner of the first aspect, the method further includes:

when the agent UE and the at least one piece of UE in the UE group need to be handed over, sending the handover request message to the T-eNB by using a mobility management entity MME, where the handover request message includes at least the context information of the agent UE and the at least one piece of to-be-handed-over UE that needs to be handed over and the cooperative relationship between the agent UE and the to-be-handed-over UE;

receiving, by using the MME, the handover configuration message sent by the T-eNB and sending the handover configuration message to the agent UE, where the handover configuration message includes at least the PRACH resource and the C-RNTI that are allocated by the T-eNB to the agent UE and the C-RNTI that is allocated by the T-eNB to each piece of to-be-handed-over UE that needs to be handed over; and

receiving, by using the MME, the context release message sent by the T-eNB, and releasing the context resources of the agent UE and the to-be-handed-over UE.

According to a second aspect, an embodiment of the present invention provides a method for handover of a user equipment group, where the method includes:

sending a measurement report of agent UE and a measurement report of UE in a user equipment UE group to a serving base station S-eNB, where the UE group includes the agent UE and each piece of UE;

receiving a handover configuration message sent by the S-eNB, where the handover configuration message includes at least a physical random access channel PRACH resource and a cell radio network temporary identifier C-RNTI that are allocated by the T-eNB to the agent UE and a C-RNTI that is allocated by the T-eNB to each piece of to-be-handed-over UE that needs to be handed over;

sending a handover configuration message separately to each piece of to-be-handed-over UE, where the handover configuration message includes at least the C-RNTI that is allocated by the T-eNB to the to-be-handed-over UE; and

initiating random access to the T-eNB according to the PRACH resource, and establishing an uplink synchronous connection to the T-eNB.

In a first possible implementation manner of the second aspect, after the establishing an uplink synchronous connection to the T-eNB, the method further includes:

sending a first handover complete message to the T-eNB;

sending a second handover complete message separately to each piece of to-be-handed-over UE in the UE group; and

receiving a third handover complete message sent by each piece of to-be-handed-over UE in the UE group and forwarding the third handover complete message to the T-eNB.

In a second possible implementation manner of the second aspect, after the initiating random access to the T-eNB according to the PRACH resource, the method further includes:

if the initiating random access to the T-eNB according to the PRACH resource fails, initiating a synchronous-connection re-establishment request; and

if synchronous-connection re-establishment fails, sending a re-establishment notification message to each piece of to-be-handed-over UE in the UE group, to instruct each piece of to-be-handed-over UE in the UE group to separately establish a synchronous connection.

According to a third aspect, an embodiment of the present invention provides a method for handover of a user equipment group, where the method includes:

sending a measurement report to agent user equipment UE, so that the agent UE forwards the measurement report and a measurement report of the agent UE to a serving base station S-eNB;

receiving a handover configuration message sent by the agent UE, where the handover configuration message includes at least a cell radio network temporary identifier C-RNTI that is allocated by a target base station T-eNB; and

completing handover of to-be-handed-over UE according to the C-RNTI, and sending a third handover complete message to the agent UE, so that the agent UE forwards the handover complete message to the target base station T-eNB.

According to a fourth aspect, an embodiment of the present invention provides a method for handover of a user equipment group, where the method includes:

receiving a handover request message sent by a serving base station S-eNB, where the handover request message includes at least context information of agent user equipment UE and at least one piece of to-be-handed-over UE that is in a UE group and that needs to be handed over and a cooperative relationship between the agent UE and the to-be-handed-over UE;

allocating resources to the agent UE and each piece of to-be-handed-over UE that is in the UE group and that needs to be handed over, where the resources include at least a physical random access channel PRACH resource and a cell radio network temporary identifier C-RNTI that are allocated to the agent UE and a C-RNTI that is allocated to each piece of to-be-handed-over UE that needs to be handed over;

sending a handover configuration message to the S-eNB, where the handover configuration message includes at least the PRACH resource and the C-RNTI that are allocated to the agent UE and the C-RNTI that is allocated to each piece of to-be-handed-over UE that needs to be handed over;

receiving an access request that is sent by the agent UE according to the PRACH resource, and establishing an uplink synchronous connection to the agent UE; and

receiving a handover complete message that indicates that the to-be-handed-over UE has completed handover according to the C-RNTI and that is forwarded by the agent UE, to learn that the to-be-handed-over UE has completed the handover.

In a first possible implementation manner of the fourth aspect, after the receiving a handover complete message that indicates that the to-be-handed-over UE has completed handover according to the C-RNTI and that is forwarded by the agent UE, the method further includes:

sending a path conversion request to a mobility management entity MME;

receiving a path conversion confirm message that is sent by the MME after the MME converts downlink paths of the agent UE and the to-be-handed-over UE according to the path conversion request; and

sending a context release message to the MME, so that the MME sends a context release command to the S-eNB, to cause the S-eNB to release context resources of the agent UE and the to-be-handed-over UE.

According to a fifth aspect, an embodiment of the present invention provides a device for handover of a user equipment group, where the device includes:

a handover determining module, configured to determine, according to a measurement report of the agent user equipment UE and a measurement report of UE in a UE group that are sent by the agent user equipment UE, whether the agent UE and each piece of UE in the UE group need to be handed over, where the UE group includes the agent UE and each piece of UE;

a handover requesting module, configured to: when the agent UE and at least one piece of UE in the UE group need to be handed over, send a handover request message to a target base station T-eNB, where the handover request message includes at least context information of the agent UE and the at least one piece of to-be-handed-over UE that needs to be handed over and a cooperative relationship between the agent UE and the to-be-handed-over UE;

a handover confirming module, configured to receive a handover configuration message sent by the T-eNB and send the handover configuration message to the agent UE, where the handover configuration message includes at least a physical random access channel PRACH resource and a cell radio network temporary identifier C-RNTI that are allocated by the T-eNB to the agent UE and a C-RNTI that is allocated by the T-eNB to each piece of to-be-handed-over UE that needs to be handed over; and

a first releasing module, configured to receive a context release message sent by the T-eNB, and release context resources of the agent UE and the to-be-handed-over UE.

In a first possible implementation manner of the fifth aspect, the device further includes:

a first forwarding module, configured to: when the agent UE and the at least one piece of UE in the UE group need to be handed over, send the handover request message to the T-eNB by using a mobility management entity MME, where the handover request message includes at least the context information of the agent UE and the at least one piece of to-be-handed-over UE that needs to be handed over and the cooperative relationship between the agent UE and the to-be-handed-over UE;

a second forwarding module, configured to receive, by using the MME, the handover configuration message sent by the T-eNB and send the handover configuration message to the agent UE, where the handover configuration message includes at least the PRACH resource and the C-RNTI that are allocated by the T-eNB to the agent UE and the C-RNTI that is allocated by the T-eNB to each piece of to-be-handed-over UE that needs to be handed over; and

a third forwarding module, configured to receive, by using the MME, the context release message sent by the T-eNB, and release the context resources of the agent UE and the to-be-handed-over UE.

According to a sixth aspect, an embodiment of the present invention provides a device for handover of a user equipment group, where the device includes:

a first sending module, configured to send a measurement report of agent UE and a measurement report of each piece of UE in a user equipment UE group to a serving base station S-eNB, where the UE group includes the agent UE and each piece of UE;

a confirmation receiving module, configured to receive a handover configuration message sent by the S-eNB, where the handover configuration message includes at least a physical random access channel PRACH resource and a cell radio network temporary identifier C-RNTI that are allocated by the T-eNB to the agent UE and a C-RNTI that is allocated by the T-eNB to each piece of to-be-handed-over UE that needs to be handed over;

an identifier sending module, configured to send a handover configuration message separately to each piece of to-be-handed-over UE, where the handover configuration message includes at least the C-RNTI that is allocated by the T-eNB to the to-be-handed-over UE; and

a first access module, configured to initiate random access to the T-eNB according to the PRACH resource, and establish an uplink synchronous connection to the T-eNB.

In a first possible implementation manner of the sixth aspect, the device further includes:

a first handover completing module, configured to: after the uplink synchronous connection to the T-eNB is established, send a first handover complete message to the T-eNB; and send a second handover complete message separately to each piece of to-be-handed-over UE in the UE group; and

a second handover completing module, configured to receive a third handover complete message sent by each piece of to-be-handed-over UE in the UE group and forward the third handover complete message to the T-eNB.

In a second possible implementation manner of the sixth aspect, the device further includes:

a second access module, configured to: after the random access to the T-eNB is initiated according to the PRACH resource, if the random access to the T-eNB initiated according to the PRACH resource fails, initiate a synchronous-connection re-establishment request; and if synchronous-connection re-establishment fails, send a re-establishment notification message to each piece of to-be-handed-over UE in the UE group, to instruct each piece of to-be-handed-over UE in the UE group to separately establish a synchronous connection.

According to a seventh aspect, an embodiment of the present invention provides a device for handover of a user equipment group, where the device includes:

a second sending module, configured to send a measurement report to agent user equipment UE, so that the agent UE forwards the measurement report and a measurement report of the agent UE to a serving base station S-eNB;

an identifier receiving module, configured to receive a handover configuration message sent by the agent UE, where the handover configuration message includes at least a cell radio network temporary identifier C-RNTI that is allocated by a target base station T-eNB; and

a third handover completing module, configured to complete handover of to-be-handed-over UE according to the C-RNTI, and send a third handover complete message to the agent UE, so that the agent UE forwards the handover complete message to the target base station T-eNB.

According to an eighth aspect, an embodiment of the present invention provides a device for handover of a user equipment group, where the device includes:

a handover receiving module, configured to receive a handover request message sent by a serving base station S-eNB, where the handover request message includes at least context information of agent user equipment UE and at least one piece of to-be-handed-over UE that needs to be handed over and a cooperative relationship between the agent UE and the to-be-handed-over UE;

an identifier allocating module, configured to allocate resources to the agent UE and each piece of to-be-handed-over UE that is in the UE group and that needs to be handed over, where the resources include at least a physical random access channel PRACH resource and a cell radio network temporary identifier C-RNTI that are allocated to the agent UE and a C-RNTI that is allocated to each piece of to-be-handed-over UE that needs to be handed over; and send a handover configuration message to the S-eNB, where the handover configuration message includes at least the PRACH resource and the C-RNTI that are allocated to the agent UE and the C-RNTI that is allocated to each piece of to-be-handed-over UE that needs to be handed over;

a third access module, configured to receive an access request that is sent by the agent UE according to the PRACH resource, and establish an uplink synchronous connection to the agent UE; and

a fourth handover completing module, configured to receive a handover complete message that indicates that the to-be-handed-over UE has completed handover according to the C-RNTI and that is forwarded by the agent UE, to learn that the to-be-handed-over UE has completed the handover.

In a first possible implementation manner of the eighth aspect, the device further includes:

a path conversion requesting module, configured to: after the handover complete message that indicates that the to-be-handed-over UE has completed the handover according to the C-RNTI and that is forwarded by the agent UE is received, send a path conversion request to a mobility management entity MME;

a path conversion confirming module, configured to receive a path conversion confirm message that is sent by the MME after the MME converts downlink paths of the agent UE and the to-be-handed-over UE according to the path conversion request; and

a second releasing module, configured to send a context release message to the MME, so that the MME sends a context release command to the S-eNB, to cause the S-eNB to release context resources of the agent UE and the to-be-handed-over UE.

According to a ninth aspect, an embodiment of the present invention provides a system for handover of a user equipment group, where the system includes:

a serving base station S-eNB, agent user equipment UE, to-be-handed-over UE in an agent group, and a target base station T-eNB, where

the S-eNB is configured to implement the function according to the first aspect;

the agent UE is configured to implement the function according to the second aspect;

the to-be-handed-over UE in the agent group is configured to implement the function according to the third aspect; and

the target base station T-eNB is configured to implement the function according to the fourth aspect.

Beneficial effects of the technical solutions provided by the embodiments of the present invention are as follows:

When it is determined that agent UE and at least one piece of UE in a UE group need to be handed over, a handover request message is sent to a T-eNB; a handover configuration message sent by the T-eNB is received and is sent to the agent UE, where the handover configuration message includes at least a PRACH resource and a C-RNTI that are allocated by the T-eNB to the agent UE and a C-RNTI that is allocated by the T-eNB to each piece of to-be-handed-over UE that needs to be handed over; and a context release message sent by the T-eNB is received, and context resources of the agent UE and the to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for handover of a user equipment group according to Embodiment 1 of the present invention;

FIG. 2 is a flowchart of a method for handover of a user equipment group according to

Embodiment 2 of the present invention;

FIG. 3 is a flowchart of a method for handover of a user equipment group according to Embodiment 3 of the present invention;

FIG. 4 is a flowchart of a method for handover of a user equipment group according to Embodiment 4 of the present invention;

FIG. 5 is a flowchart of a method for handover of a user equipment group according to Embodiment 5 of the present invention;

FIG. 6 is a schematic operational diagram of the method for handover of a user equipment group according to Embodiment 5 of the present invention;

FIG. 7 is a flowchart of a method for handover of a user equipment group according to Embodiment 6 of the present invention;

FIG. 8 is a schematic operational diagram of the method for handover of a user equipment group according to Embodiment 6 of the present invention;

FIG. 9 is a first schematic structural diagram of a device for handover of a user equipment group according to Embodiment 7 of the present invention;

FIG. 10 is a second schematic structural diagram of the device for handover of a user equipment group according to Embodiment 7 of the present invention;

FIG. 11 is a first schematic structural diagram of a device for handover of a user equipment group according to Embodiment 8 of the present invention;

FIG. 12 is a second schematic structural diagram of the device for handover of a user equipment group according to Embodiment 8 of the present invention;

FIG. 13 is a third schematic structural diagram of the device for handover of a user equipment group according to Embodiment 8 of the present invention;

FIG. 14 is a first schematic structural diagram of a device for handover of a user equipment group according to Embodiment 9 of the present invention;

FIG. 15 is a first schematic structural diagram of a device for handover of a user equipment group according to Embodiment 10 of the present invention;

FIG. 16 is a second schematic structural diagram of a device for handover of a user equipment group according to Embodiment 10 of the present invention; and

FIG. 17 is a schematic structural diagram of a system for handover of a user equipment group according to Embodiment 11 of the present invention.

### DESCRIPTION OF EMBODIMENTS

To make the objectives, technical solutions, and advantages of the present invention clearer, the following further describes the embodiments of the present invention in detail with reference to the accompanying drawings.

### Embodiment

### 1

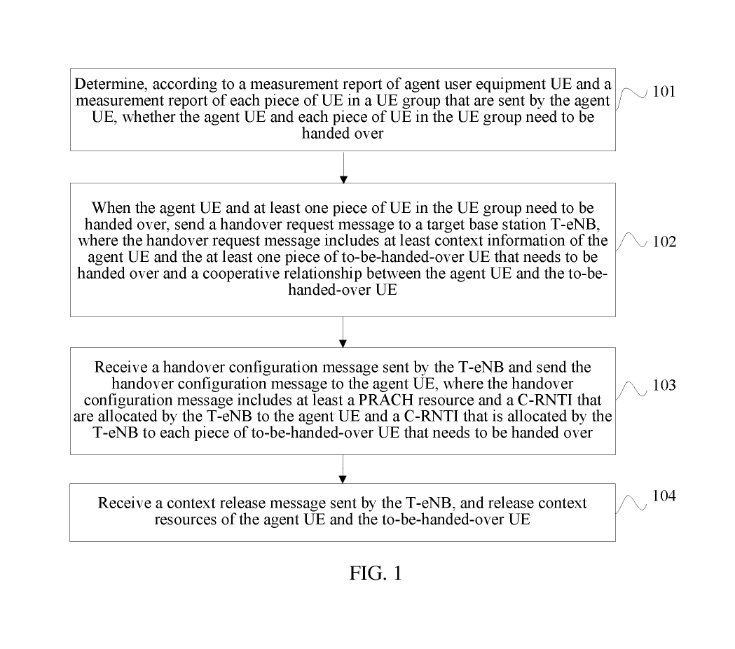

Referring to FIG. 1, an embodiment of the present invention provides a method for handover of a user equipment group, where the method includes:

101: Determine, according to a measurement report of agent user equipment UE and a measurement report of UE in a UE group that are sent by the agent UE, whether the agent UE and each piece of UE in the UE group need to be handed over, where the UE group includes the agent UE and each piece of UE.

102: When the agent UE and at least one piece of UE in the UE group need to be handed over, send a handover request message to a target base station T-eNB, where the handover request message includes at least context information of the agent UE and the at least one piece of to-be-handed-over UE that needs to be handed over and a cooperative relationship between the agent UE and the to-be-handed-over UE.

103: Receive a handover configuration message sent by the T-eNB and send the handover configuration message to the agent UE, where the handover configuration message includes at least a PRACH (Physical Random Access Channel, physical random access channel) resource and a C-RNTI (Cell Radio Network Temporary Identifier, cell radio network temporary identifier) that are allocated by the T-eNB to the agent UE and a C-RNTI that is allocated by the T-eNB to each piece of to-be-handed-over UE that needs to be handed over.

104: Receive a context release message sent by the T-eNB, and release context resources of the agent UE and the to-be-handed-over UE.

Specifically, the method further includes:

when the agent UE and the at least one piece of UE in the UE group need to be handed over, sending the handover request message to the T-eNB by using a mobility management entity MME, where the handover request message includes at least the context information of the agent UE and the at least one piece of to-be-handed-over UE that needs to be handed over and the cooperative relationship between the agent UE and the to-be-handed-over UE;

receiving, by using the MME, the handover configuration message sent by the T-eNB and sending the handover configuration message to the agent UE, where the handover configuration message includes at least the PRACH resource and the C-RNTI that are allocated by the T-eNB to the agent UE and the C-RNTI that is allocated by the T-eNB to each piece of to-be-handed-over UE that needs to be handed over; and

receiving, by using the MME, the context release message sent by the T-eNB, and releasing the context resources of the agent UE and the to-be-handed-over UE.

In the method provided by this embodiment of the present invention, when it is determined that agent UE and at least one piece of UE in a UE group need to be handed over, a handover request message is sent to a T-eNB; a handover configuration message sent by the T-eNB is received and is sent to the agent UE, where the handover configuration message includes at least a PRACH resource and a C-RNTI that are allocated by the T-eNB to the agent UE and a C-RNTI that is allocated by the T-eNB to each piece of to-be-handed-over UE that needs to be handed over;

and a context release message sent by the T-eNB is received, and context resources of the agent UE and the to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 2

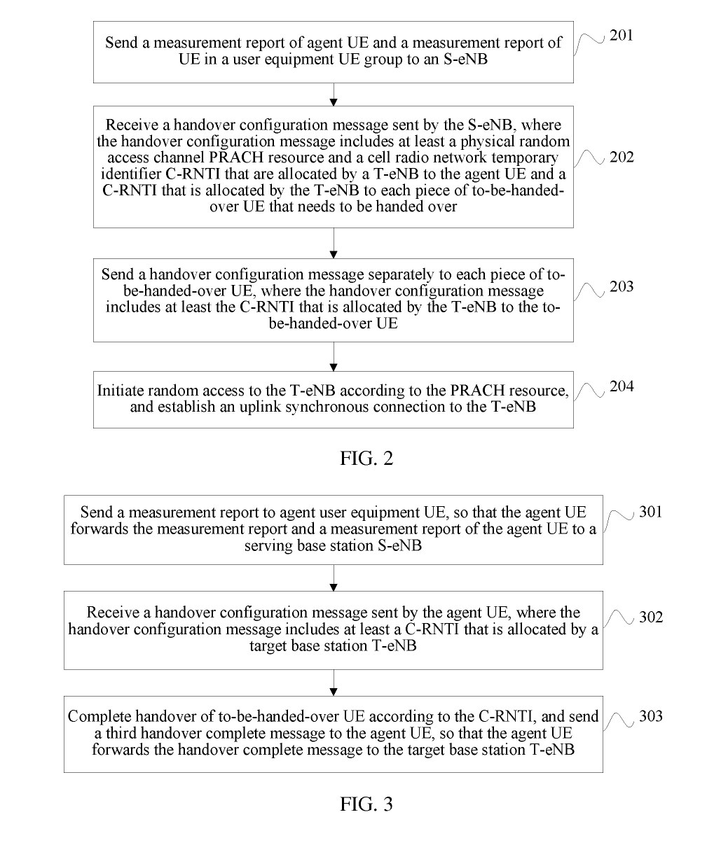

Referring to FIG. 2, an embodiment of the present invention provides a method for handover of a user equipment group, where the method includes:

201: Send a measurement report of agent UE and a measurement report of UE in a user equipment UE group to an S-eNB (Serving eNB, serving base station), where the UE group includes the agent UE and each piece of UE.

202: Receive a handover configuration message sent by the S-eNB, where the handover configuration message includes at least a physical random access channel PRACH resource and a cell radio network temporary identifier C-RNTI that are allocated by a T-eNB to the agent UE and a C-RNTI that is allocated by the T-eNB to each piece of to-be-handed-over UE that needs to be handed over.

203: Send a handover configuration message separately to each piece of to-be-handed-over UE, where the handover configuration message includes at least the C-RNTI that is allocated by the T-eNB to the to-be-handed-over UE.

204: Initiate random access to the T-eNB according to the PRACH resource, and establish an uplink synchronous connection to the T-eNB.

Specifically, after the uplink synchronous connection to the T-eNB is established, the method further includes:

sending a first handover complete message to the T-eNB;

sending a second handover complete message separately to each piece of to-be-handed-over UE in the UE group; and receiving a third handover complete message sent by each piece of to-be-handed-over UE in the UE group and forwarding the third handover complete message to the T-eNB.

Specifically, after the initiating random access to the T-eNB according to the PRACH resource, the method further includes:

if the initiating random access to the T-eNB according to the PRACH resource fails, initiating a synchronous-connection re-establishment request; and

if synchronous-connection re-establishment fails, sending a re-establishment notification message to each piece of to-be-handed-over UE in the UE group, to instruct each piece of to-be-handed-over UE in the UE group to separately establish a synchronous connection.

In the method provided by this embodiment of the present invention, a measurement report of agent UE and a measurement report of UE in a UE group are sent to an S-eNB; a handover configuration message sent by the S-eNB is received; a handover configuration message is sent separately to each piece of to-be-handed-over UE; and random access to a T-eNB is initiated according to a PRACH resource, and an uplink synchronous connection to the T-eNB is established, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 3

Referring to FIG. 3, an embodiment of the present invention provides a method for handover of a user equipment group, where the method includes:

301: Send a measurement report to agent user equipment UE, so that the agent UE forwards the measurement report and a measurement report of the agent UE to a serving base station S-eNB.

302: Receive a handover configuration message sent by the agent UE, where the handover configuration message includes at least a cell radio network temporary identifier C-RNTI that is allocated by a target base station T-eNB.

303: Complete handover of to-be-handed-over UE according to the C-RNTI, and send a third handover complete message to the agent UE, so that the agent UE forwards the handover complete message to the target base station T-eNB.

In the method provided by this embodiment of the present invention, a measurement report is sent to agent UE; a handover configuration message sent by the agent UE is received; and handover of to-be-handed-over UE is completed according to a C-RNTI, and a third handover complete message is sent to the agent UE, so that the agent UE notifies a T-eNB of the handover complete message, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 4

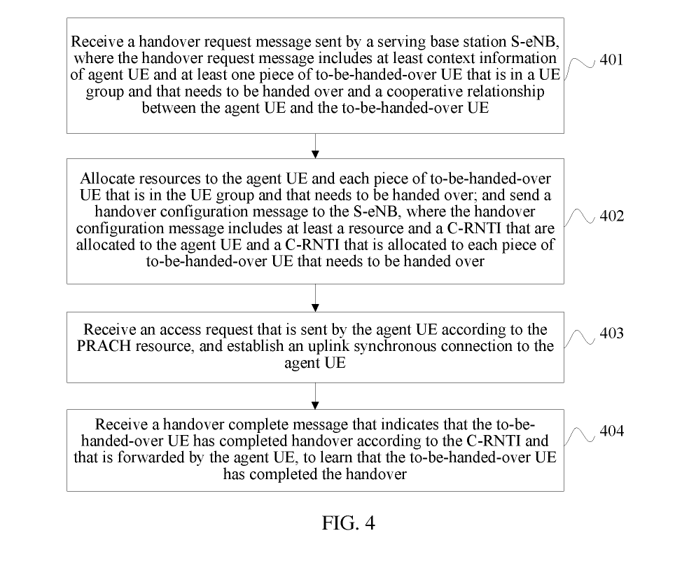

Referring to FIG. 4, an embodiment of the present invention provides a method for handover of a user equipment group, where the method includes:

401: Receive a handover request message sent by a serving base station S-eNB, where the handover request message includes at least context information of agent UE and at least one piece of to-be-handed-over UE that is in a UE group and that needs to be handed over and a cooperative relationship between the agent UE and the to-be-handed-over UE.

402: Allocate resources to the agent UE and each piece of to-be-handed-over UE that is in the UE group and that needs to be handed over, where the resources include at least a physical random access channel PRACH resource and a cell radio network temporary identifier C-RNTI that are allocated to the agent UE and a C-RNTI that is allocated to each piece of to-be-handed-over UE that needs to be handed over; and send a handover configuration message to the S-eNB, where the handover configuration message includes at least the PRACH resource and the C-RNTI that are allocated to the agent UE and the C-RNTI that is allocated to each piece of to-be-handed-over UE that needs to be handed over.

403: Receive an access request that is sent by the agent UE according to the PRACH resource, and establish an uplink synchronous connection to the agent UE.

404: Receive a handover complete message that indicates that the to-be-handed-over UE has completed handover according to the C-RNTI and that is forwarded by the agent UE, to learn that the to-be-handed-over UE has completed the handover.

Specifically, after the receiving a handover complete message that indicates that the to-be-handed-over UE has completed handover according to the C-RNTI and that is forwarded by the agent UE, the method further includes:

sending a path conversion request to a mobility management entity MME;

receiving a path conversion confirm message that is sent by the MME after the MME converts downlink paths of the agent UE and the to-be-handed-over UE according to the path conversion request; and

sending a context release message to the MME, so that the MME sends a context release command to the S-eNB, to cause the S-eNB to release context resources of the agent UE and the to-be-handed-over UE.

In the method provided by this embodiment of the present invention, a handover request message sent by an S-eNB is received, resources are allocated to agent UE and each piece of to-be-handed-over UE that is in a UE group and that needs to be handed over; a handover configuration message is sent to the S-eNB; an access request that is sent by the agent UE according to a PRACH resource is received, and an uplink synchronous connection to the agent UE is established; and a handover complete message that indicates that the to-be-handed-over UE has completed handover according to a C-RNTI and that is forwarded by the agent UE is received, to learn that the to-be-handed-over UE has completed the handover, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 5

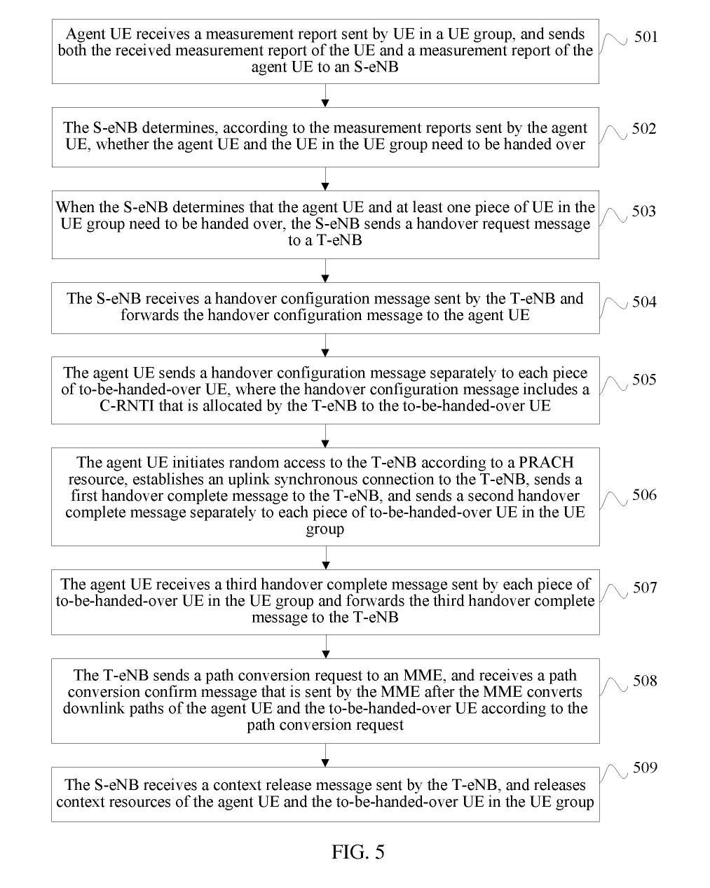

Referring to FIG. 5, an embodiment of the present invention provides a method for handover of a user equipment group, where the method includes:

501: Agent UE receives a measurement report sent by UE in a UE group, and sends both the received measurement report of the UE and a measurement report of the agent UE to an S-eNB.

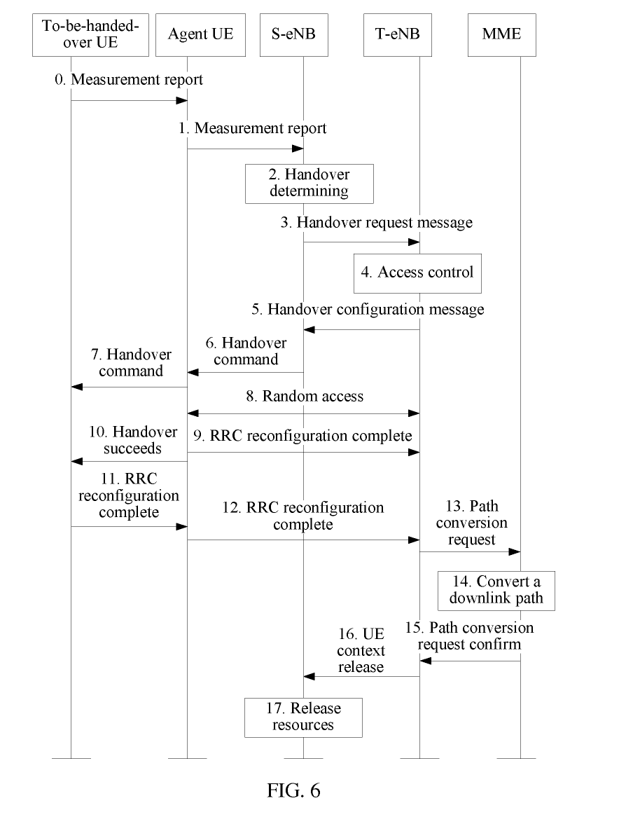

Specifically, in a UE group, an intermediate UE that plays a forwarding role is referred to as the agent UE, and is also referred to as S-UE (Supporting UE, supporting UE), and UE whose measurement report is forwarded is referred to as a B-UE (Benefitted UE, benefitted UE). One piece of agent UE may support multiple UEs; and the agent UE and each piece of UE supported by the agent UE form the UE group. Referring to FIG. 6, in step 0, UE sends a measurement report to agent UE; and in step 1, the agent UE sends both the measurement report of each piece of UE and a measurement report of the agent UE to an S-eNB.

502: The S-eNB determines, according to the measurement reports sent by the agent UE, whether the agent UE and the UE in the UE group need to be handed over.

The measurement reports include the measurement report of the agent UE and the measurement report of each piece of to-be-handed-over UE in the UE group. After receiving the measurement reports sent by the agent UE, the S-eNB determines, according to a preset rule, whether the agent UE and the to-be-handed-over UE in the UE group need to be handed over, for example, determines a communication status of the UE according to a channel communication quality parameter, so as to determine whether handover is needed. Referring to FIG. 6, in step 2, the S-eNB performs handover determining

503: When the S-eNB determines that the agent UE and at least one piece of UE in the UE group need to be handed over, the S-eNB sends a handover request message to a T-eNB.

Specifically, the handover request message includes at least context information of the agent UE and the at least one piece of to-be-handed-over UE that needs to be handed over and a cooperative relationship between the agent UE and the to-be-handed-over UE. The S-eNB determines, according to the measurement reports sent by the agent UE, whether the agent UE and the UE in the UE group need to be handed over, and if the agent UE and the at least one piece of UE in the UE group need to be handed over, the S-eNB sends a handover request message to the T-eNB. The other UEs that do not need to be handed over re-establish a synchronous connection. If the S-eNB determines that neither the agent UE nor the UE in the UE group needs to be handed over, the S-eNB does not send a handover request message to the T-eNB. Referring to FIG. 6, in step 3, the S-eNB sends a handover request message to a T-eNB.

504: The S-eNB receives a handover configuration message sent by the T-eNB and forwards the handover configuration message to the agent UE.

Specifically, the handover configuration message includes at least a PRACH resource and a C-RNTI that are allocated by the T-eNB to the agent UE and a C-RNTI that is allocated by the T-eNB to each piece of to-be-handed-over UE that needs to be handed over, where the PRACH resource includes a Preamble. Referring to FIG. 6, in step 4, the T-eNB performs access control, and allocates a PRACH resource to the agent UE and allocates a C-RNTI to the agent UE and each piece of to-be-handed-over UE that is allowed to perform accessing; in step 5, the T-eNB sends a handover configuration message to the S-eNB; and in step 6, after receiving the handover configuration message, the S-eNB sends a handover command (RRC connection reconfiguration message) to the agent UE, where the handover command includes the PRACH resource and the C-RNTI that are allocated to the agent UE and the C-RNTI that is allocated to each piece of to-be-handed-over UE that needs to be handed over.

505: The agent UE sends a handover configuration message separately to each piece of to-be-handed-over UE, where the handover configuration message includes a C-RNTI that is allocated by the T-eNB to the to-be-handed-over UE.

Specifically, after receiving the handover configuration message, the agent UE takes out the PRACH resource and the C-RNTI of the agent UE, and then sends the handover configuration message separately to each piece of to-be-handed-over UE, where the handover configuration message includes at least the C-RNTI that is allocated by the T-eNB to the to-be-handed-over UE. Referring to FIG. 6, in step 7, the agent UE separately sends a handover command (RRC connection reconfiguration message) to each piece of to-be-handed-over UE that is allowed to perform handover, where the RRC connection reconfiguration message includes the C-RNTI that is allocated by the T-eNB to the to-be-handed-over UE in the UE group and other related information.

It should be noted that, for each piece of to-be-handed-over UE, when the S-eNB determines that the to-be-handed-over UE needs to be handed over, if the to-be-handed-over UE does not receive the handover configuration message including the C-RNTI that is allocated by the T-eNB to the to-be-handed-over UE, the to-be-handed-over UE sends a random access request to the S-eNB, and establishes a synchronous connection to directly communicate with the S-eNB.

506: The agent UE initiates random access to the T-eNB according to a PRACH resource, establishes an uplink synchronous connection to the T-eNB, sends a first handover complete message to the T-eNB, and sends a second handover complete message separately to each piece of to-be-handed-over UE in the UE group.

Specifically, referring to FIG. 6, in step 8, the agent UE initiates contention-free random access to the T-eNB according to the PRACH resource, and obtains a timing advance of the T-eNB and permission of sending uplink data; in step 9, the agent UE sends a first handover complete message, that is, an RRC reconfiguration complete message, to the T-eNB, to indicate that the agent UE has completed the handover; and in step 10, the agent UE sends a second handover complete message to the UE that is allowed to perform handover, to notify that the agent UE has completed the handover.

It should be noted that, after the agent UE initiates the random access to the T-eNB according to the PRACH resource, if the random access to the T-eNB that is initiated according to the PRACH resource fails, a synchronous-connection re-establishment request is initiated; and

if synchronous-connection re-establishment fails, a re-establishment notification message is sent to each piece of to-be-handed-over UE in the UE group, to instruct each piece of to-be-handed-over UE in the UE group to separately establish a synchronous connection.

507: The agent UE receives a third handover complete message sent by each piece of to-be-handed-over UE in the UE group and forwards the third handover complete message to the T-eNB.

Specifically, referring to FIG. 6, in step 11, each piece of to-be-handed-over UE that is allowed to perform handover sends a third handover complete message, that is, a reconfiguration complete message, to the agent UE, to indicate that each piece of to-be-handed-over UE has completed the handover; and in step 12, the agent UE forwards, to the T-eNB, the third handover complete message, that is, the reconfiguration complete message, of each piece of to-be-handed-over UE that is allowed to perform handover.

508: The T-eNB sends a path conversion request to an MME, and receives a path conversion confirm message that is sent by the MME after the MME converts downlink paths of the agent UE and the to-be-handed-over UE according to the path conversion request.

Specifically, referring to FIG. 6, in step 13, the T-eNB sends a path conversion request message to an MME, to request to convert a downlink path of each piece of UE that succeeds in handover; in step 14, the MME and an S-GW complete conversion of the downlink path of each piece of UE; and in step 15, the MME sends a path conversion request confirm message to the T-eNB.

509: The S-eNB receives a context release message sent by the T-eNB, and releases context resources of the agent UE and the to-be-handed-over UE in the UE group.

Specifically, referring to FIG. 6, in step 16, the T-eNB sends a UE context release message to the S-eNB; and in step 17, the S-eNB releases context resources of all UEs that succeed in handover.

In the method provided by this embodiment of the present invention, when it is determined that agent UE and at least one piece of UE in a UE group need to be handed over, a handover request message is sent to a T-eNB; and a handover configuration message including a PRACH resource and a C-RNTI that are allocated by the T-eNB to the agent UE and a C-RNTI that is allocated by the T-eNB to each piece of to-be-handed-over UE that needs to be handed over is sent to the agent UE, and when the agent UE and each piece of to-be-handed-over UE complete handover, context resources of the agent UE and each piece of to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 6

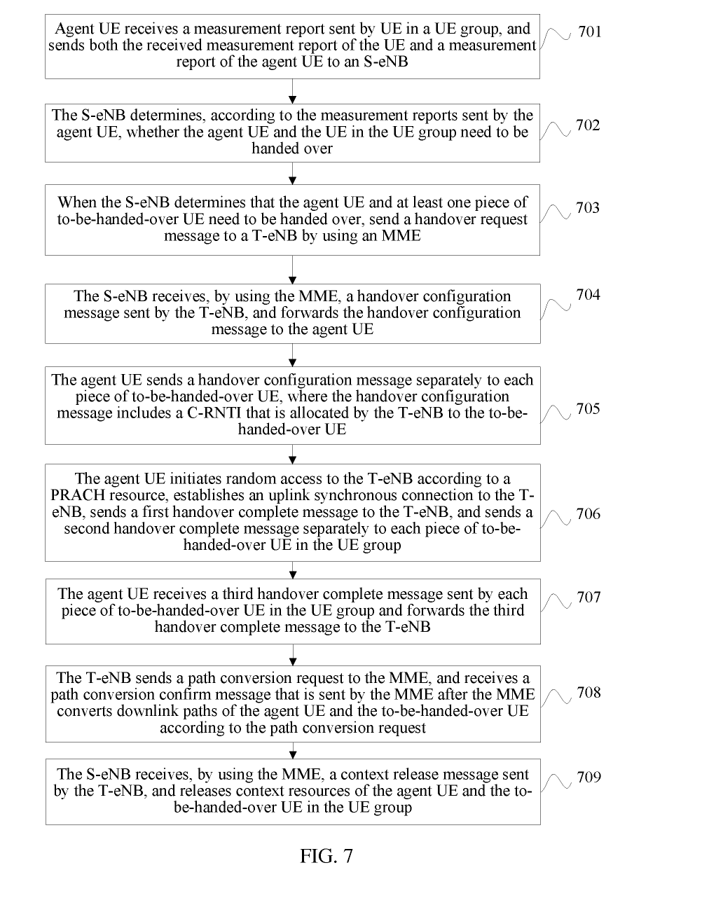

Referring to FIG. 7, an embodiment of the present invention provides a method for handover of a user equipment group, where the method includes:

701: Agent UE receives a measurement report sent by UE in a UE group, and sends both the received measurement report of the UE and a measurement report of the agent UE to an S-eNB.

702: The S-eNB determines, according to the measurement reports sent by the agent UE, whether the agent UE and the UE in the UE group need to be handed over.

For specific processes of step 701 and step 702, refer to steps 501 and 502 of Embodiment 2, and details are not described again.

703: When the S-eNB determines that the agent UE and at least one piece of to-be-handed-over UE in the UE group need to be handed over, the S-eNB sends a handover request message to a T-eNB by using an MME.

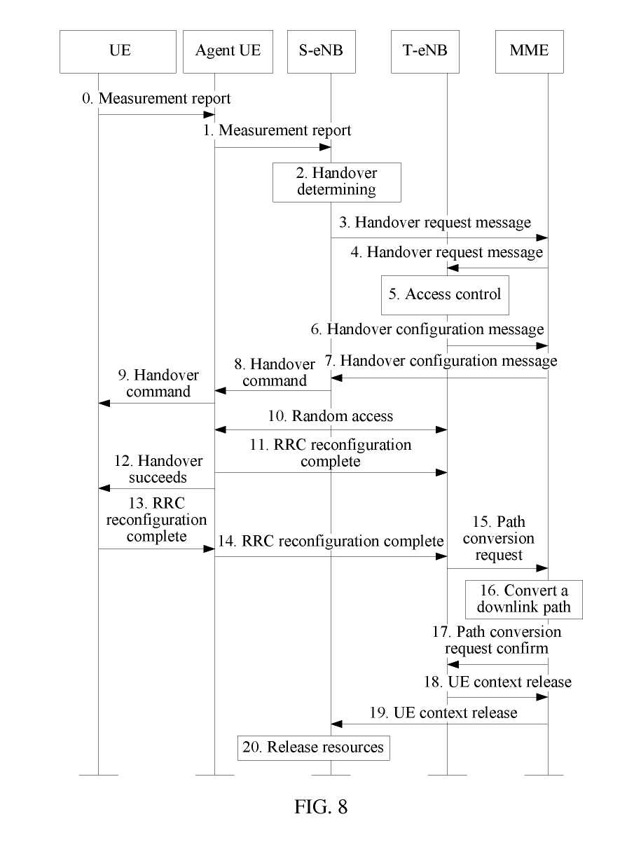

Specifically, the handover request message includes at least context information of the agent UE and the at least one piece of to-be-handed-over UE that needs to be handed over and a cooperative relationship between the agent UE and the to-be-handed-over UE. The S-eNB determines, according to the measurement reports sent by the agent UE, whether the agent UE and the UE in the UE group need to be handed over, and if the agent UE and the at least one piece of UE in the UE group need to be handed over, the S-eNB sends a handover request message to the T-eNB by using the MME. The other UEs that do not need to be handed over re-establish a synchronous connection. If the S-eNB determines that neither the agent UE nor the UE in the UE group needs to be handed over, the S-eNB does not send a handover request message to the T-eNB. Referring to FIG. 8, in step 3, an S-eNB sends a handover request message to an MME; and in step 4, the MME sends the handover request message to a T-eNB.

704: The S-eNB receives, by using the MME, a handover configuration message sent by the T-eNB, and forwards the handover configuration message to the agent UE.

Specifically, the handover configuration message includes at least a PRACH resource and a C-RNTI that are allocated by the T-eNB to the agent UE and a C-RNTI that is allocated by the T-eNB to each piece of to-be-handed-over UE that needs to be handed over, where the PRACH resource includes a Preamble.

Referring to FIG. 8, in step 5, the T-eNB performs access control, and allocates a PRACH resource to the agent UE and allocates a C-RNTI to the agent UE and each piece of to-be-handed-over UE that is allowed to perform accessing; in step 6, the T-eNB sends a handover configuration message to the MME; in step 7, the MME sends the handover configuration message to the S-eNB; in step 8, after receiving the handover configuration message, the S-eNB sends a handover command (RRC connection reconfiguration message) to the agent UE, where the handover command includes the PRACH resource and the C-RNTI that are allocated to the agent UE and the C-RNTI that is allocated to each piece of to-be-handed-over UE that needs to be handed over.

705: The agent UE sends a handover configuration message separately to each piece of to-be-handed-over UE, where the handover configuration message includes a C-RNTI that is allocated by the T-eNB to the to-be-handed-over UE.

706: The agent UE initiates random access to the T-eNB according to a PRACH resource, establishes an uplink synchronous connection to the T-eNB, sends a first handover complete message to the T-eNB, and sends a second handover complete message separately to each piece of to-be-handed-over UE in the UE group.

707: The agent UE receives a third handover complete message sent by each piece of to-be-handed-over UE in the UE group and forwards the third handover complete message to the T-eNB.

708: The T-eNB sends a path conversion request to the MME, and receives a path conversion confirm message that is sent by the MME after the MME converts downlink paths of the agent UE and the to-be-handed-over UE according to the path conversion request.

For specific processes of step 705 to step 708, refer to steps 505 to 508 of Embodiment 2, and details are not described again.

709: The S-eNB receives, by using the MME, a context release message sent by the

T-eNB, and releases context resources of the agent UE and the to-be-handed-over UE in the UE group.

Specifically, referring to FIG. 8, in step 18, the T-eNB sends a UE context release message to the MME; and in step 19, after receiving the UE context release message sent by the MME, the S-eNB releases context resources of all UEs that succeed in handover.

In the method provided by this embodiment of the present invention, when it is determined that agent UE and at least one piece of UE in a UE group need to be handed over, a handover request message is sent to a T-eNB by using an MME; and a handover configuration message including a PRACH resource and a C-RNTI that are allocated by the T-eNB to the agent UE and a C-RNTI that is allocated by the T-eNB to each piece of to-be-handed-over UE that needs to be handed over is sent to the agent UE, and when the agent UE and each piece of to-be-handed-over UE complete handover, a release request of the T-eNB is received by using the MME, and context resources of the agent UE and each piece of to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 7

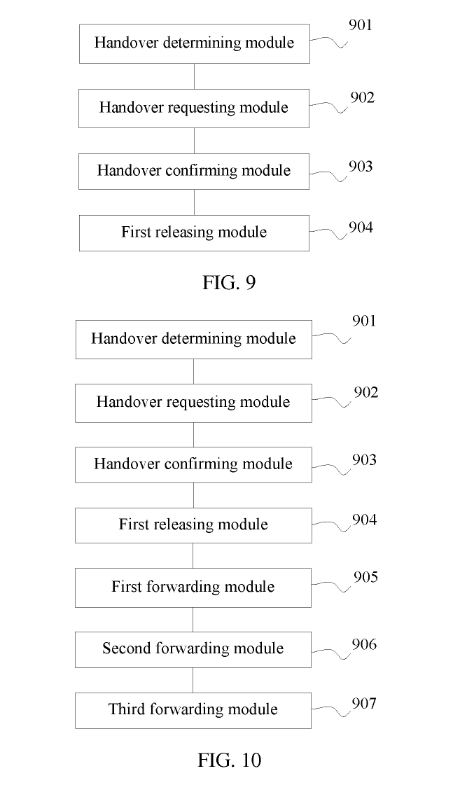

Referring to FIG. 9, an embodiment of the present invention provides a device for handover of a user equipment group, where the device includes:

a handover determining module 901, configured to determine, according to a measurement report of agent user equipment UE and a measurement report of UE in a UE group that are sent by the agent UE, whether the agent UE and each piece of UE in the UE group need to be handed over, where the UE group includes the agent UE and each piece of UE;

a handover requesting module 902, configured to: when the agent UE and at least one piece of UE in the UE group need to be handed over, send a handover request message to a target base station T-eNB, where the handover request message includes at least context information of the agent UE and the at least one piece of to-be-handed-over UE that needs to be handed over and a cooperative relationship between the agent UE and the to-be-handed-over UE;

a handover confirming module 903, configured to receive a handover configuration message sent by the T-eNB and send the handover configuration message to the agent UE, where the handover configuration message includes at least a physical random access channel PRACH resource and a cell radio network temporary identifier C-RNTI that are allocated by the T-eNB to the agent UE and a C-RNTI that is allocated by the T-eNB to each piece of to-be-handed-over UE that needs to be handed over; and

a first releasing module 904, configured to receive a context release message sent by the T-eNB, and release context resources of the agent UE and the to-be-handed-over UE.

Specifically, referring to FIG. 10, the device further includes:

a first forwarding module 905, configured to: when the agent UE and the at least one piece of UE in the UE group need to be handed over, send the handover request message to the T-eNB by using a mobility management entity MME, where the handover request message includes at least the context information of the agent UE and the at least one piece of to-be-handed-over UE that needs to be handed over and the cooperative relationship between the agent UE and the to-be-handed-over UE;

a second forwarding module 906, configured to receive, by using the MME, the handover configuration message sent by the T-eNB and send the handover configuration message to the agent UE, where the handover configuration message includes at least the PRACH resource and the C-RNTI that are allocated by the T-eNB to the agent UE and the C-RNTI that is allocated by the T-eNB to each piece of to-be-handed-over UE that needs to be handed over; and

a third forwarding module 907, configured to receive, by using the MME, the context release message sent by the T-eNB, and release the context resources of the agent UE and the to-be-handed-over UE.

In the device provided by this embodiment of the present invention, when it is determined that agent UE and at least one piece of UE in a UE group need to be handed over, a handover request message is sent to a T-eNB; a handover configuration message sent by the T-eNB is received and is sent to the agent UE, where the handover configuration message includes at least a PRACH resource and a C-RNTI that are allocated by the T-eNB to the agent UE and a C-RNTI that is allocated by the T-eNB to each piece of to-be-handed-over UE that needs to be handed over; and a context release message sent by the T-eNB is received, and context resources of the agent UE and the to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 8

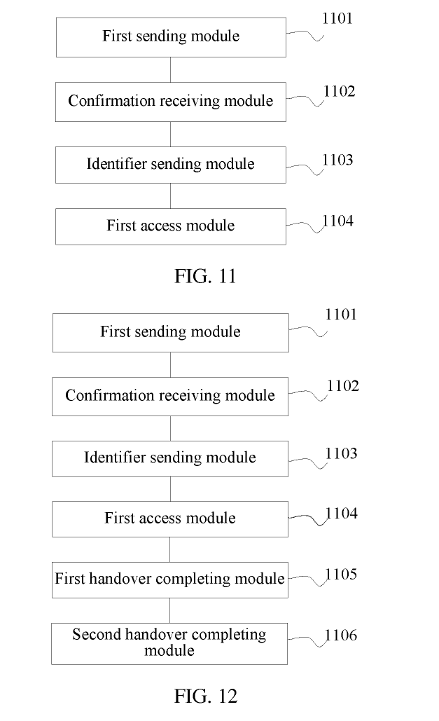

Referring to FIG. 11, an embodiment of the present invention provides a device for handover of a user equipment group, where the device includes:

a first sending module 1101, configured to send a measurement report of agent UE and a measurement report of each piece of UE in a user equipment UE group to a serving base station S-eNB, where the UE group includes the agent UE and each piece of UE;

a confirmation receiving module 1102, configured to receive a handover configuration message sent by the S-eNB, where the handover configuration message includes at least a physical random access channel PRACH resource and a cell radio network temporary identifier C-RNTI that are allocated by a T-eNB to the agent UE and a C-RNTI that is allocated by the T-eNB to each piece of to-be-handed-over UE that needs to be handed over;

an identifier sending module 1103, configured to send a handover configuration message separately to each piece of to-be-handed-over UE, where the handover configuration message includes at least the C-RNTI that is allocated by the T-eNB to the to-be-handed-over UE; and

a first access module 1104, configured to initiate random access to the T-eNB according to the PRACH resource, and establish an uplink synchronous connection to the T-eNB.

Specifically, referring to FIG. 12, the device further includes:

a first handover completing module 1105, configured to: after the uplink synchronous connection to the T-eNB is established, send a first handover complete message to the T-eNB; and send a second handover complete message separately to each piece of to-be-handed-over UE in the UE group; and

a second handover completing module 1106, configured to receive a third handover complete message sent by each piece of to-be-handed-over UE in the UE group and forward the third handover complete message to the T-eNB.

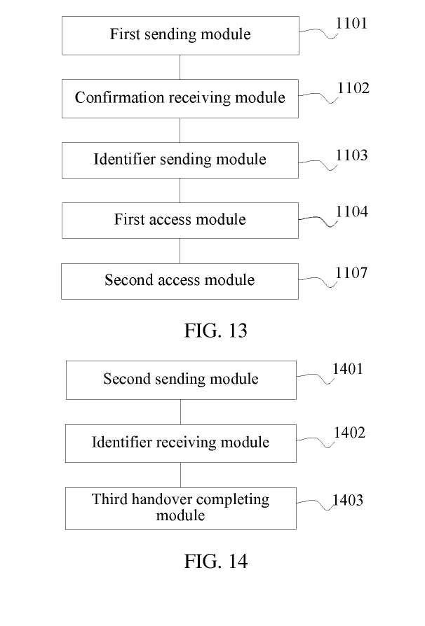

Specifically, referring to FIG. 13, the device further includes:

a second access module 1107, configured to: after the random access to the T-eNB is initiated according to the PRACH resource, if the random access to the T-eNB initiated according to the PRACH resource fails, initiate a synchronous-connection re-establishment request; and if synchronous-connection re-establishment fails, send a re-establishment notification message to each piece of to-be-handed-over UE in the UE group, to instruct each piece of to-be-handed-over UE in the UE group to separately establish a synchronous connection.

In the device provided by this embodiment of the present invention, a measurement report of agent UE and a measurement report of UE in a UE group are sent to an S-eNB; a handover configuration message sent by the S-eNB is received; a handover configuration message is sent separately to each piece of to-be-handed-over UE; and random access to a T-eNB is initiated according to a PRACH resource, and an uplink synchronous connection to the T-eNB is established, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

Embodiment 9

Referring to FIG. 14, an embodiment of the present invention provides a device for handover of a user equipment group, where the device includes: a second sending module 1401, configured to send a measurement report to agent user equipment UE, so that the agent UE forwards the measurement report and a measurement report of the agent UE to a serving base station S-eNB;

an identifier receiving module 1402, configured to receive a handover configuration message sent by the agent UE, where the handover configuration message includes at least a cell radio network temporary identifier C-RNTI that is allocated by a target base station T-eNB; and a third handover completing module 1403, configured to complete handover of to-be-handed-over UE according to the C-RNTI, and send a third handover complete message to the agent UE, so that the agent UE forwards the handover complete message to the T-eNB.

In the device provided by this embodiment of the present invention, a measurement report is sent to agent UE; a handover configuration message sent by the agent UE is received; and handover of to-be-handed-over UE is completed according to a C-RNTI, and a third handover complete message is sent to the agent UE, so that the agent UE notifies a T-eNB of the handover complete message, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 10

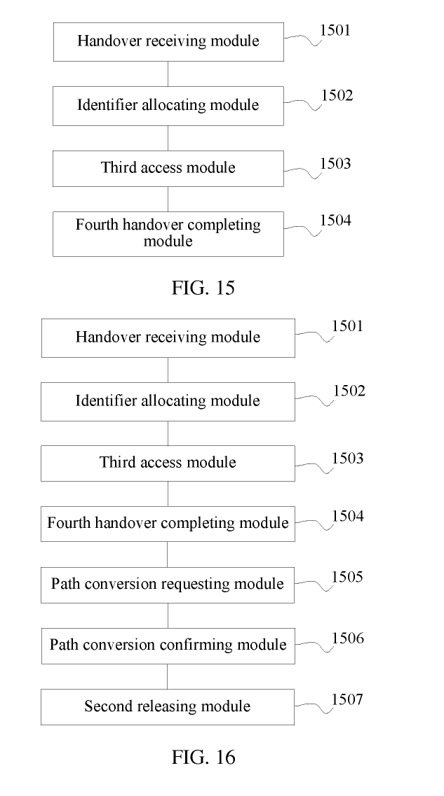

Referring to FIG. 15, an embodiment of the present invention provides a device for handover of a user equipment group, where the device includes:

a handover receiving module 1501, configured to receive a handover request message sent by a serving base station S-eNB, where the handover request message includes at least context information of agent UE and at least one piece of to-be-handed-over UE that needs to be handed over and a cooperative relationship between the agent UE and the to-be-handed-over UE;

an identifier allocating module 1502, configured to allocate resources to the agent UE and each piece of to-be-handed-over UE that is in the UE group and that needs to be handed over, where the resources include at least a physical random access channel PRACH resource and a cell radio network temporary identifier C-RNTI that are allocated to the agent UE and a C-RNTI that is allocated to each piece of to-be-handed-over UE that needs to be handed over; and send a handover configuration message to the S-eNB, where the handover configuration message includes at least the PRACH resource and the C-RNTI that are allocated to the agent UE and the C-RNTI that is allocated to each piece of to-be-handed-over UE that needs to be handed over;

a third access module 1503, configured to receive an access request that is sent by the agent UE according to the PRACH resource, and establish an uplink synchronous connection to the agent UE; and

a fourth handover completing module 1504, configured to receive a handover complete message that indicates that the to-be-handed-over UE has completed handover according to the C-RNTI and that is forwarded by the agent UE, to learn that the to-be-handed-over UE has completed the handover.

Specifically, referring to FIG. 16, the device further includes:

a path conversion requesting module 1505, configured to: after the handover complete message that indicates that the to-be-handed-over UE has completed the handover according to the C-RNTI and that is forwarded by the agent UE is received, send a path conversion request to a mobility management entity MME;

a path conversion confirming module 1506, configured to receive a path conversion confirm message that is sent by the MME after the MME converts downlink paths of the agent UE and the to-be-handed-over UE according to the path conversion request; and

a second releasing module 1507, configured to send a context release message to the MME, so that the MME sends a context release command to the S-eNB, to cause the S-eNB to release context resources of the agent UE and the to-be-handed-over UE.

In the device provided by this embodiment of the present invention, when a handover request message sent by an S-eNB is received, resources are allocated to agent UE and each piece of to-be-handed-over UE that is in a UE group and that needs to be handed over; a handover configuration message is sent to the S-eNB; an access request that is sent by the agent UE according to a PRACH resource is received, and an uplink synchronous connection to the agent UE is established; and a handover complete message that indicates that the to-be-handed-over UE has completed handover according to a C-RNTI and that is forwarded by the agent UE is received, to learn that the to-be-handed-over UE has completed the handover, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

### Embodiment 11

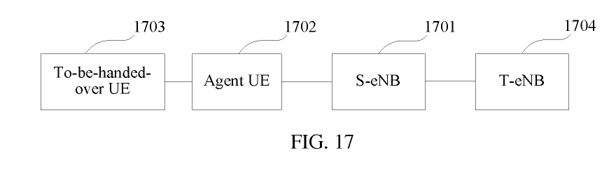

Referring to FIG. 17, an embodiment of the present invention provides a system for handover of a user equipment group, where the system includes:

a serving base station S-eNB 1701, agent user equipment UE 1702, to-be-handed-over UE 1703 in the UE group, and a target base station T-eNB 1704, where

the S-eNB 1701 is configured to implement the function according to Embodiment 7, and specific steps are not described again;

the agent UE 1702 is configured to implement the function according to Embodiment 8, and specific steps are not described again;

the to-be-handed-over UE 1703 is configured to implement the function according to Embodiment 9, and specific steps are not described again; and

the target base station T-eNB 1704 is configured to implement the function according to Embodiment 10, and specific steps are not described again.

In the system provided by this embodiment of the present invention, when it is determined that agent UE and at least one piece of UE in a UE group need to be handed over, a handover request message is sent to a T-eNB; a handover configuration message sent by the T-eNB is received and is sent to the agent UE, where the handover configuration message includes at least a PRACH resource and a C-RNTI that are allocated by the T-eNB to the agent UE and a C-RNTI that is allocated by the T-eNB to each piece of to-be-handed-over UE that needs to be handed over; and a context release message sent by the T-eNB is received, and context resources of the agent UE and the to-be-handed-over UE are released, thereby resolving a problem that currently a large quantity of Preambles and signaling need to be consumed because agent UE and each piece of to-be-handed-over UE need to perform handover separately with a T-eNB during handover of a user equipment group and a problem of redundant synchronization in a single link MUCC state, saving Preamble resources and signaling, and improving handover efficiency.

It should be noted that: when the device for handover of a user equipment group that is provided by the foregoing embodiments performs handover of a user equipment group, division of the foregoing functional modules is taken as an example for illustration. In actual application, the foregoing functions can be allocated to different functional modules and implemented according to a requirement, that is, an inner structure of a device is divided into different functional modules to implement all or some of the functions described above. In addition, the device and system for handover of a user equipment group that are provided by the foregoing embodiments pertain to a same concept as the embodiments of the method for handover of a user equipment group. For a specific implementation process of the device and system, refer to the method embodiments, and details are not described herein again.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

1. A method for handover of a user equipment group, the method comprising:
determining, according to a measurement report of an agent user equipment (UE) and a measurement report of UE in a UE group that are sent by the agent UE, whether the agent UE and each UE in the UE group need to be handed over, wherein the UE group comprises the agent UE and each UE;
when the agent UE and at least one UE in the UE group need to be handed over, sending a handover request message to a target base station (T-eNB), wherein the handover request message comprises at least context information of the agent UE and the at least one to-be-handed-over UE that needs to be handed over and a cooperative relationship between the agent UE and the to-be-handed-over UE;
receiving a handover configuration message sent by the T-eNB and sending the handover configuration message to the agent UE, wherein the handover configuration message comprises at least a physical random access channel (PRACH) resource and a cell radio network temporary identifier (C-RNTI) that are allocated by the T-eNB to the agent UE and a C-RNTI that is allocated by the T-eNB to each to-be-handed-over UE that needs to be handed over;
receiving a context release message sent by the T-eNB, and releasing context resources of the agent UE and the to-be-handed-over UE;
initiating random access to the T-eNB according to the PRACH resource, and establishing an uplink synchronous connection to the T-eNB, wherein after the initiating random access to the T-eNB according to the PRACH resource, the method further comprises:
if the initiating random access to the T-eNB according to the PRACH resource fails, initiating a synchronous-connection re-establishment request; and
if synchronous-connection re-establishment fails, sending a re-establishment notification message to each to-be-handed-over UE in the UE group, to instruct each to-be-handed-over UE in the UE group to separately establish a synchronous connection.

2. The method according to claim 1, further comprising:
when the agent UE and the at least one piece of UE in the UE group need to be handed over, sending the handover request message to the T-eNB by using a mobility management entity (MME), wherein the handover request message comprises at least the context information of the agent UE and the at least one piece of to-be-handed-over UE that needs to be handed over and the cooperative relationship between the agent UE and the to-be-handed-over UE;
receiving, by using the MME, the handover configuration message sent by the T-eNB and sending the handover configuration message to the agent UE, wherein the handover configuration message comprises at least the PRACH resource and the C-RNTI that are allocated by the T-eNB to the agent UE and the C-RNTI that is allocated by the T-eNB to each to-be-handed-over UE that needs to be handed over; and
receiving, by using the MME, the context release message sent by the T-eNB, and releasing the context resources of the agent UE and the to-be-handed-over UE.

3. A method for handover of a user equipment group, the method comprising:
sending a measurement report of agent UE and a measurement report of each UE in a user equipment (UE) group to a serving base station S-eNB, wherein the UE group comprises the agent UE and each UE;
receiving a handover configuration message sent by the S-eNB, wherein the handover configuration message comprises at least a physical random access channel (PRACH) resource and a cell radio network temporary identifier (C-RNTI) that are allocated by a T-eNB to the agent UE and a C-RNTI that is allocated by the T-eNB to each to-be-handed-over UE that needs to be handed over;
sending a handover configuration message separately to each to-be-handed-over UE, wherein the handover configuration message comprises at least the C-RNTI that is allocated by the T-eNB to the to-be-handed-over UE; and
initiating random access to the T-eNB according to the PRACH resource, and establishing an uplink synchronous connection to the T-eNB, wherein after the initiating random access to the T-eNB according to the PRACH resource, the method further comprises:
if the initiating random access to the T-eNB according to the PRACH resource fails, initiating a synchronous-connection re-establishment request; and
if synchronous-connection re-establishment fails, sending a re-establishment notification message to each to-be-handed-over UE in the UE group, to instruct each to-be-handed-over UE in the UE group to separately establish a synchronous connection.

4. The method according to claim 3, wherein after the establishing an uplink synchronous connection to the T-eNB, the method further comprises:
sending a first handover complete message to the T-eNB;
sending a second handover complete message separately to each to-be-handed-over UE in the UE group; and
receiving a third handover complete message sent by each to-be-handed-over UE in the UE group and forwarding the third handover complete message to the T-enB.

5. (canceled)

6. A method for handover of a user equipment group, the method comprising:
sending a measurement report to agent user equipment (UE), so that the agent UE forwards the measurement report and a measurement report of the agent UE to a serving base station S-eNB;
receiving a handover configuration message sent by the agent UE, wherein the handover configuration message comprises at least a cell radio network temporary identifier (C-RNTI) that is allocated by a target base station (T-eNB);
completing handover of to-be-handed-over UE according to the C-RNTI, and sending a third handover complete message to the agent UE, so that the agent UE forwards the handover complete message to the T-eNB;
initiating random access to the T-eNB according to a physical random access channel (PRACH) resource, and establishing an uplink synchronous connection to the T-eNB, wherein after the initiating random access to the T-eNB according to the PRACH resource, the method further comprises:
if the initiating random access to the T-eNB according to the PRACH resource fails, initiating a synchronous-connection re-establishment request; and
if synchronous-connection re-establishment fails, sending a re-establishment notification message to each to-be-handed-over UE in the UE group, to instruct each to-be-handed-over UE in the UE group to separately establish a synchronous connection.

7. A method for handover of a user equipment group, the method comprising:
receiving a handover request message sent by a serving base station S-eNB, wherein the handover request message comprises at least context information of agent user equipment (UE) and at least one piece of to-be-handed-over UE that is in a UE group and that needs to be handed over and a cooperative relationship between the agent UE and the to-be-handed-over UE;
allocating resources to the agent UE and each to-be-handed-over UE that is in the UE group and that needs to be handed over, wherein the resources comprise at least a physical random access channel (PRACH) resource and a cell radio network temporary identifier (C-RNTI) that are allocated to the agent UE and a C-RNTI that is allocated to each to-be-handed-over UE that needs to be handed over;
sending a handover configuration message to the S-eNB, wherein the handover configuration message comprises at least the PRACH resource and the C-RNTI that are allocated to the agent UE and the C-RNTI that is allocated to each to-be-handed-over UE that needs to be handed over;
receiving an access request that is sent by the agent UE according to the PRACH resource, and establishing an uplink synchronous connection to the agent UE;
receiving a handover complete message that indicates that the to-be-handed-over UE has completed handover according to the C-RNTI and that is forwarded by the agent UE, to learn that the to-be-handed-over UE has completed the handover;
initiating random access to the T-eNB according to a physical random access channel (PRACH) resource, and establishing an uplink synchronous connection to the T-eNB, wherein after the initiating random access to the T-eNB according to the PRACH resource, the method further comprises:
if the initiating random access to the T-eNB according to the PRACH resource fails, initiating a synchronous-connection re-establishment request; and
if synchronous-connection re-establishment fails, sending a re-establishment notification message to each to-be-handed-over UE in the UE group, to instruct each to-be-handed-over UE in the UE group to separately establish a synchronous connection.

8. The method according to claim 7, wherein after the receiving a handover complete message that indicates that the to-be-handed-over UE has completed handover according to the C-RNTI and that is forwarded by the agent UE, the method further comprises:
sending a path conversion request to a mobility management entity (MME);
receiving a path conversion confirm message that is sent by the MME after the MME converts downlink paths of the agent UE and the to-be-handed-over UE according to the path conversion request; and
sending a context release message to the MME, so that the MME sends a context release command to the S-eNB, to cause the S-eNB to release context resources of the agent UE and the to-be-handed-over UE.

9. A device for handover of a user equipment group, the device comprising:
a processor, configured to determine, according to a measurement report of the agent user equipment (UE) and a measurement report of UE in a UE group that are sent by the agent UE, whether the agent UE and each UE in the UE group need to be handed over, wherein the UE group comprises the agent UE and each UE;
a transmitter, configured to: when the agent UE and at least one piece of UE in the UE group need to be handed over, send a handover request message to a target base station (T-eNB), wherein the handover request message comprises at least context information of the agent UE and the at least one piece of to-be-handed-over UE that needs to be handed over and a cooperative relationship between the agent UE and the to-be-handed-over UE;
a receiver, configured to receive a handover configuration message sent by the T-eNB; and
the transmitter, configured to send the handover configuration message to the agent UE, wherein the handover configuration message comprises at least a physical random access channel (PRACH) resource and a cell radio network temporary identifier (C-RNTI) that are allocated by the T-eNB to the agent UE and a C-RNTI that is allocated by the T-eNB to each piece-of to-be-handed-over UE that needs to be handed over; and
the receiver, configured to receive a context release message sent by the T-eNB, and
the processor, configured to release context resources of the agent UE and the to-be-handed-over UE, wherein the processor further configured to initiate random access to the T-eNB according to the PRACH resource, and establish an uplink synchronous connection to the T-eNB and further configured to: after the random access to the T-eNB is initiated according to the PRACH resource, if the random access to the T-eNB initiated according to the PRACH resource fails, initiate a synchronous-connection re-establishment request; and the transmitter, configured to: if synchronous-connection re-establishment fails, send a re-establishment notification message to each to-be-handed-over UE in the UE group, to instruct each to-be-handed-over UE in the UE group to separately establish a synchronous connection.

10. The device according to claim 9, wherein the transmitter, configured to: when the agent UE and the at least one piece of UE in the UE group need to be handed over, send the handover request message to the T-eNB by using a mobility management entity (MME), wherein the handover request message comprises at least the context information of the agent UE and the at least one piece of to-be-handed-over UE that needs to be handed over and the cooperative relationship between the agent UE and the to-be-handed-over UE;
the receiver, configured to receive, by using the MME, the handover configuration message sent by the T-eNB; and
the transmitter, configured to send the handover configuration message to the agent UE, wherein the handover configuration message comprises at least the PRACH resource and the C-RNTI that are allocated by the T-eNB to the agent UE and the C-RNTI that is allocated by the T-eNB to each to-be-handed-over UE that needs to be handed over; and
the receiver, configured to receive, by using the MME, the context release message sent by the T-eNB, and release the context resources of the agent UE and the to-be-handed-over UE.

11. A device for handover of a user equipment group, the device comprising:
a transmitter, configured to send a measurement report of agent UE and a measurement report of each UE in a user equipment (UE) group to a serving base station S-eNB, wherein the UE group comprises the agent UE and each UE;
a receiver, configured to receive a handover configuration message sent by the S-eNB, wherein the handover configuration message comprises at least a physical random access channel (PRACH) resource and a cell radio network temporary identifier (C-RNTI) that are allocated by the T-eNB to the agent UE and a C-RNTI that is allocated by the T-eNB to each to-be-handed-over UE that needs to be handed over;
the transmitter, configured to send a handover configuration message separately to each to-be-handed-over UE, wherein the handover configuration message comprises at least the C-RNTI that is allocated by the T-eNB to the to-be-handed-over UE; and
a processor, configured to initiate random access to the T-eNB according to the PRACH resource, and establish an uplink synchronous connection to the T-eNB, wherein the processor further configured to: after the random access to the T-eNB is initiated according to the PRACH resource, if the random access to the T-eNB initiated according to the PRACH resource fails, initiate a synchronous-connection re-establishment request; and the transmitter, configured to: if synchronous-connection re-establishment fails, send a re-establishment notification message to each to-be-handed-over UE in the UE group, to instruct each to-be-handed-over UE in the UE group to separately establish a synchronous connection.

12. The device according to claim 11, wherein the transmitter, configured to: after the uplink synchronous connection to the T-eNB is established, send a first handover complete message to the T-eNB; and send a second handover complete message separately to each to-be-handed-over UE in the UE group; and
the receiver, configured to receive a third handover complete message sent by each piece-of to-be-handed-over UE in the UE group and forward the third handover complete message to the T-eNB.

13. (canceled)

14. A device for handover of a user equipment group, the device comprising:
a transmitter, configured to send a measurement report to agent user equipment (UE), so that the agent UE forwards the measurement report and a measurement report of the agent UE to a serving base station S-eNB;
a receiver, configured to receive a handover configuration message sent by the agent UE, wherein the handover configuration message comprises at least a cell radio network temporary identifier (C-RNTI) that is allocated by a target base station (T-eNB); and
a processor, configured to complete handover of to-be-handed-over UE according to the C-RNTI, and
the transmitter, configured to send a third handover complete message to the agent UE, so that the agent UE forwards the handover complete message to the T-eNB, wherein the processor further configured to initiate random access to the T-eNB according to a physical random access channel (PRACH) resource, and establish an uplink synchronous connection to the T-eNB and further configured to: after the random access to the T-eNB is initiated according to the PRACH resource, if the random access to the T-eNB initiated according to the PRACH resource fails, initiate a synchronous-connection re-establishment request; and the transmitter, configured to: if synchronous-connection re-establishment fails, send a re-establishment notification message to each to-be-handed-over UE in the UE group, to instruct each to-be-handed-over UE in the UE group to separately establish a synchronous connection.

15. A device for handover of a user equipment group, the device comprising:
a receiver, configured to receive a handover request message sent by a serving base station S-eNB, wherein the handover request message comprises at least context information of agent user equipment (UE) and at least one piece of to-be-handed-over UE that needs to be handed over and a cooperative relationship between the agent UE and the to-be-handed-over UE;
a processor, configured to allocate resources to the agent UE and each to-be-handed-over UE that is in the UE group and that needs to be handed over, wherein the resources comprise at least a physical random access channel (PRACH) resource and a cell radio network temporary identifier (C-RNTI) that are allocated to the agent UE and a C-RNTI that is allocated to each to-be-handed-over UE that needs to be handed over; and send a handover configuration message to the S-eNB, wherein the handover configuration message comprises at least the PRACH resource and the C-RNTI that are allocated to the agent UE and the C-RNTI that is allocated to each to-be-handed-over UE that needs to be handed over;
the receiver, configured to receive an access request that is sent by the agent UE according to the PRACH resource, and establish an uplink synchronous connection to the agent UE;
the receiver, configured to receive a handover complete message that indicates that the to-be-handed-over UE has completed handover according to the C-RNTI and that is forwarded by the agent UE, to learn that the to-be-handed-over UE has completed the handover, wherein the processor further configured to initiate random access to the T-eNB according to the PRACH resource, and establish an uplink synchronous connection to the T-eNB and further configured to: after the random access to the T-eNB is initiated according to the PRACH resource, if the random access to the T-eNB initiated according to the PRACH resource fails, initiate a synchronous-connection re-establishment request; and
a transmitter, configured to: if synchronous-connection re-establishment fails, send a re-establishment notification message to each to-be-handed-over UE in the UE group, to instruct each to-be-handed-over UE in the UE group to separately establish a synchronous connection.

16. The device according to claim 15, wherein the device further comprises:
the transmitter, configured to: after the handover complete message that indicates that the to-be-handed-over UE has completed the handover according to the C-RNTI and that is forwarded by the agent UE is received, send a path conversion request to a mobility management entity (MME);
the receiver, configured to receive a path conversion confirm message that is sent by the MME after the MME converts downlink paths of the agent UE and the to-be-handed-over UE according to the path conversion request; and
the transmitter, configured to send a context release message to the MME, so that the MME sends a context release command to the S-eNB, to cause the S-eNB to release context resources of the agent UE and the to-be-handed-over UE.
